(19) United States
(12) Patent Application Publication
(10) Pub. No.: US 2017/0066595 A1
(43) Pub. Date: Mar. 9, 2017

(54) CONVEYOR GUIDE WALL WITH DAMPING ROLLERS

(71) Applicant: Laitram, L.L.C., Harahan, LA (US)

(72) Inventor: Matthew L. Fourney, Laurel, MD (US)

(21) Appl. No.: 14/847,836

(22) Filed: Sep. 8, 2015

(51) Int. Cl. B65G 21/20

(52) U.S. Cl. CPC B65G 21/2054

(57) ABSTRACT

A conveyor guide wall constructed of a series of parallel columns of freely rotatable rollers. The rollers are mounted on rods retained within top and bottom rails. The rollers rotate on the rods to provide a guide that engages conveyed articles in low-friction rolling contact. Voids in the rollers increase the rollers' flexibility and help absorb impacts with conveyed articles.

### BACKGROUND

The invention relates generally to power-driven conveyors and more particularly to guides positioned alongside or within a stream of conveyed articles.

Guide walls are often used alongside, across, or within a stream of conveyed articles to guide the articles along a conveyor. Usually the walls have static surfaces along which the articles slide as they are being conveyed. Bead or roller rails, or guides, are used to replace the sliding friction of static guides with lower rolling friction. These low-friction guides are made of hard beads or rollers arranged in stacks on rods. The beads or rollers are free to rotate on the rods when contacted by an advancing article. Often the bead or roller guides are used as stops across a conveyor to divert articles to a side or as side rails along which articles can be registered. Because the beads or rollers are made of a hard material, articles can bounce off the rigid bead or roller on contact. The impact can damage the article or alter its alignment or orientation, which can degrade the transfer to another conveyor downstream.

### SUMMARY

One version of a conveyor guide wall embodying features of the invention comprises a plurality of columns of one or more rollers mounted between the top and bottom rails. Each of the roller columns is arranged to rotate on parallel axes of rotation. Each of the rollers includes a first side, a second side, and an outer periphery encircling the axis of rotation and extending axially from the first side to the second side. Voids extend through each roller from the first side to the second side between the outer periphery and the axis of rotation to absorb impacts against the outer periphery of the roller.

In another aspect of the invention, a conveyor system embodying features of the invention comprises a conveyor conveying articles in a conveying direction along a conveying plane and a guide wall arranged perpendicular to the conveying plane to contact the articles. The guide wall includes rollers that are rotatable on axes of rotation transverse to the conveying plane and that have outer peripheries to contact the articles. Each of the rollers has a plurality of voids extending through the roller between the axis of rotation and the outer periphery to absorb impacts against the outer periphery of the roller by the articles as they are conveyed in the conveying direction.

### BRIEF DESCRIPTION OF THE DRAWINGS

FIG. 1 is an isometric view of a section of a conveyor guide wall embodying features of the invention alongside a portion of a conveyor;

FIGS. 2A and 2B are isometric and side views of a roller in a guide wall as in FIG. 1;

FIG. 3 is an isometric view of a flanged sleeve bushing used in the roller of FIGS. 2A and 2B; and

FIGS. 4A and 4B are isometric and side views of a column of rollers as in the guide wall of FIG. 1.

### DETAILED DESCRIPTION

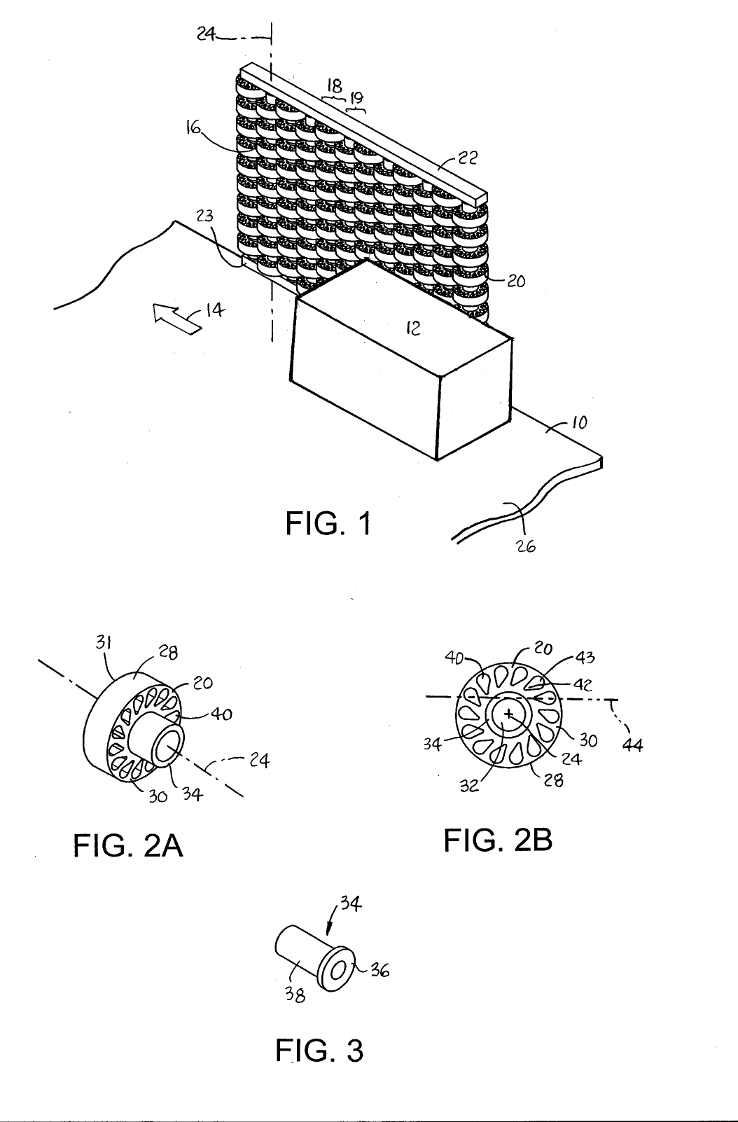

A conveyor system embodying features of the invention is shown in FIG. 1. A conveyor 10, which may be a conveyor belt as shown, a roller conveyor, or another kind of conveyor, advances articles 12 in a conveying direction 14. In particular the conveyor, whether a belt or a roller conveyor, could include article-supporting rollers arranged to rotate in a direction oblique to the conveying direction 14 to push articles toward a side of the conveyor. A guide wall 16 along a side of the conveyor 10 prevents the conveyed articles 12 from falling off the side of the conveyor and also registers the articles along the side.

The guide wall 16 comprises columns 18, 19 of stacked rollers 20 mounted between parallel top and bottom rails 22, 23. In this example the rollers 20 in adjacent columns 18, 19 are vertically offset so that they can be interleaved in a high-density pattern. But the rollers could be vertically aligned in a lower-density pattern. Each column 18, 19 of rollers 20 rotates on an axis of rotation 24 that is transverse—in this example, perpendicular—to the conveying plane 26 of the conveyor 10. To increase or decrease the pressure on the conveyor as the articles are conveyed along the guide wall 16, the axes of rotation 24 can be angled forward or rearward in the conveying direction 14—slightly off perpendicular to the conveying plane 26 of the conveyor 10. For small articles a guide wall with only a single roller in each column may suffice. The rollers 20 rotate freely on their parallel axes of rotation 24 and contact the conveyed articles 12 in low-friction, rolling contact.

One version of the rollers 20 is shown in more detail in FIGS. 2A and 2B. The roller 20 has an outer periphery 28 extending axially across the width of the roller between a first side 30 and an opposite second side 31. A central bore 32 through the roller 20 defines its axis of rotation 24. A bushing 34 is received in the central bore 32 by a press-fit, overmolding, or other means of attachment. The bushing 34 shown in FIG. 3 is a flanged sleeve bushing with a flange 36 at one end of a sleeve 38. The bushing 34 is made of a rigid plastic material, such as nylon, PEEK, or a hardened PTFE, or of a metal material such as aluminum, steel, or stainless steel, for durable, wear-resistant, low-friction rotational contact with an axle rod. The roller 20 is made of a less hard, more pliable material that is quieter and more energy-absorbing. Voids 40 extend through the roller 20 between the periphery 28 and the bore 32 from the first side 30 to the axially opposite second side 31. In this version the voids 40 extend parallel to the axis of rotation 24 and form channels that open onto the first and second sides 30, 31 of the roller 20. The voids 40 are shown regularly spaced circumferentially around the roller 20. And the voids 40 have a teardrop-shaped cross section that has a narrow end 42 nearer the bore 32 of the roller 20 tapering out to a wide end 43 nearer the periphery 28. Each of the voids 40 has an axis of symmetry 44 that does not intersect the axis of rotation 24. In this version the voids 40 extend across the width of the roller 20 parallel to the axis of rotation 24. The voids 40 allow the roller 20 to elastically deform slightly and absorb impacts with conveyed articles. By absorbing the impacts, the rollers 20 damp the motion of the articles as they strike and prevent bouncing and reorientation.

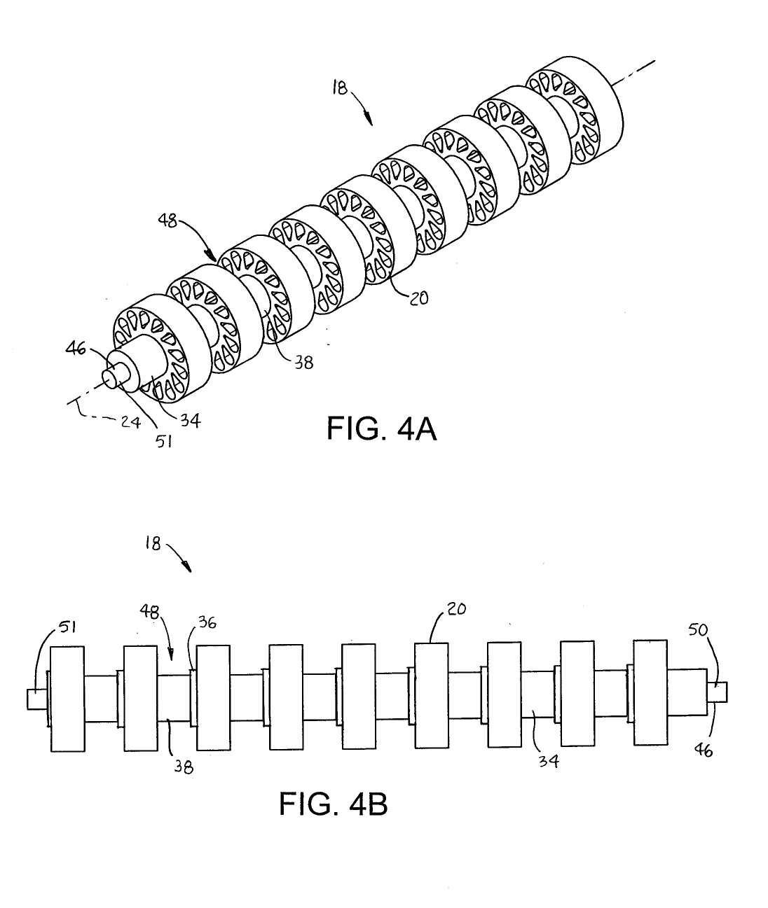

The roller columns 18 are shown in more detail in FIGS. 4A and 4B. The rollers 20 are stacked on a rod 46 that extends through the bushings 34 in the roller bores. The sleeves 38 of the bushings 34 sit on the larger-diameter flanges 36 of adjacent bushings in the column 18. The sleeves 38 are longer than the width of the rollers 20 and serve with the flanges 36 as spacers to provide a gap 48 between adjacent rollers 20 large enough to accommodate the interleaved rollers of an adjacent column 18, 19 as in FIG. 1. If the rollers of adjacent columns are not interleaved, bushings with shorter sleeves can be used. The ends 50, 51 of the rod 46 are retained in the top and bottom rails 22, 23 shown in FIG. 1.

Although the invention has been described in reference to an exemplary version, other versions are possible. For example, instead of having bushings, the rollers could be molded or machined as a single piece of material with an integral central hub that extends outward from one or both sides to space stacked rollers. As another example, the guide wall can be positioned within a stream of articles, rather than alongside as in FIG. 1, to help corral, guide, or separate the flow of articles. Or it could be used as a stop across a conveyor to divert intercepted articles to one side. So, as these few examples suggest, the scope of the claims is not meant to be limited to the details of the exemplary versions used to describe the invention.

1. A conveyor guide wall comprising:
a top rail and a bottom rail parallel to the top rail;
a plurality of columns of one or more rollers arranged between the top and bottom rails to rotate on parallel axes of rotation;
wherein each of the one or more rollers includes:
a first side and a second side;
a low-friction outer periphery encircling the axis of rotation and extending axially from the first side to the second side;
a plurality of voids extending through the roller from the first side to the second side between the outer periphery and the axis of rotation to absorb impacts against the outer periphery of the roller.

2. A conveyor guide wall as in claim 1 further comprising:
a plurality of rods retained at opposite ends in the top and bottom rails and wherein each of the rollers has a central bore and a bushing disposed in the central bore to receive one of the rods.

3. A conveyor guide wall as in claim 2 wherein the axial length of the bushing is greater than the axial distance between the first and second sides of the roller.

4. A conveyor guide wall as in claim 2 wherein the bushing is a flanged sleeve bushing having a flange at one end in contact with the first side of the roller.

5. A conveyor guide wall as in claim 2 wherein the bushing is made of a hard plastic or metallic material and the roller is made of a more pliable material.

6. A conveyor guide wall as in claim 1 wherein the voids form channels that extend parallel to the axis of rotation and that open onto the first and second sides.

7. A conveyor guide wall as in claim 1 wherein the voids are teardrop-shaped in cross section.

8. A conveyor guide wall as in claim 1 wherein each of the voids has a cross section that tapers out from a narrow end nearer the axis of rotation to a wide end nearer the periphery of the roller.

9. A conveyor guide wall as in claim 1 wherein each of the voids has a cross section with an axis of symmetry that does not intersect the axis of rotation of the roller.

10. A conveyor system comprising:
a conveyor conveying articles in a conveying direction along a conveying plane;
a guide wall arranged perpendicular to the conveying plane to contact the articles, wherein the guide wall includes:
a plurality of rollers that are rotatable on axes of rotation transverse to the conveying plane and that have low-friction outer peripheries to contact the articles,
wherein each of the rollers has a plurality of voids extending through the roller between the axis of rotation and the outer periphery to absorb impacts against the outer periphery of the roller by the articles as they are conveyed in the conveying direction.

11. A conveyor system as in claim 10 wherein the guide wall is arranged along a side of the conveyor to form a guide along the side of the conveyor to prevent articles from falling off the side and against which articles can be registered.

12. A conveyor system as in claim 10 wherein the guide wall comprises:
a top rail and a bottom rail parallel to the top rail and to the conveying plane;
wherein the plurality of rollers are arranged in a plurality of parallel columns of one or more of the rollers mounted between the top and bottom rails;
wherein each of the one or more rollers includes a first side and a second side axially spaced from the first side and joined by the outer periphery.

13. A conveyor system as in claim 12 further comprising a plurality of rods retained at opposite ends in the top and bottom rails and wherein each of the rollers has a central bore and a bushing disposed in the central bore to receive one of the rods.

14. A conveyor system as in claim 13 wherein the axial length of the bushing is greater than the axial distance between the first and second sides of the roller.

15. A conveyor system as in claim 13 wherein the bushing is a flanged sleeve bushing having a flange at one end in contact with the first side of the roller.

16. A conveyor system as in claim 10 wherein the voids form channels that extend parallel to the axis of rotation and that open onto the first and second sides.

17. A conveyor system as in claim 10 wherein each of the voids has a cross section that tapers out from a narrow end nearer the axis of rotation to a wide end nearer the periphery of the roller.
